(19) United States
(12) Patent Application Publication
(10) Pub. No.: US 2025/0028431 A1
(43) Pub. Date: Jan. 23, 2025

(54) METHOD AND APPARATUS FOR GENERATING IMAGE EFFECT PACKAGE, DEVICE, AND STORAGE MEDIUM

(71) Applicant: Beijing Bytédance Network Technology Co., Ltd., Beijing (CN)

(72) Inventors: Yang LV, Beijing (CN); Ruifeng MA, Beijing (CN)

(21) Appl. No.: 18/715,070

(22) PCT Filed: Nov. 28, 2022
(86) PCT No.: PCT/CN2022/134621

§ 371 Date: May 30, 2024

(30) Foreign Application Priority Data
Nov. 30, 2021 (CN) 202111443885.9

(51) Int. Cl. G06F 3/0484; G06F 8/38

(52) U.S. Cl. CPC G06F 3/0484; G06F 8/38

(57) ABSTRACT

The present disclosure provides an image effect package generation method and apparatus, a device, and a storage medium. The image effect package generation method includes: creating an initial effect resource through a user-triggered creation operation; importing a custom effect program file into the initial effect resource through a user-triggered import operation, to obtain a custom effect resource; creating a custom effect control based on the custom effect resource; and generating a custom image effect package based on the custom effect control.

The present application claims priority to Chinese Patent Application No. 202111443885.9, filed with the China National Intellectual Property Administration on Nov. 30, 2021, which is incorporated herein by reference in its entirety.

### TECHNICAL FIELD

The present disclosure relates to the field of computer software technologies, and for example, to an image effect package generation method and apparatus, a device, and a storage medium.

### BACKGROUND ART

With the development of computer technologies, smart terminals have been increasingly widely used. For example, the smart terminals may be used to listen to music, play games, chat online, take photos, etc. The photographing technology of the smart terminals has reached over ten million photographic pixels, which allows high definition, and photographing effects comparable to professional cameras.

When an intelligent terminal is used to take photos, the photographing effect based on a conventional feature can be achieved by using built-in camera software at the factory, and further, the photographing effect based on an additional feature can be achieved by using an application (APP) downloaded from a network side. For example, various effects for images may be achieved, such as sticker effects, filter effects, and deform effects.

### SUMMARY OF THE INVENTION

The present disclosure provides an image effect package generation method and apparatus, a device, and a storage medium, which may implement generation of a custom effect package, and improve the diversity of image effect packages.

According to a first aspect, the present disclosure provides an image effect package generation method. The method includes:
creating an initial effect resource through a user-triggered creation operation;
importing a custom effect program file into the initial effect resource through a user-triggered import operation, to obtain a custom effect resource;
creating a custom effect control based on the custom effect resource; and
generating a custom image effect package based on the custom effect control.

According to a second aspect, the present disclosure further provides an image effect package generation apparatus. The apparatus includes:
an initial effect resource creation module configured to create an initial effect resource through a user-triggered creation operation;
a custom effect resource obtaining module configured to import a custom effect program file into the initial effect resource through a user-triggered import operation, to obtain a custom effect resource;
a custom effect control creation module configured to create a custom effect control based on the custom effect resource; and
a custom image effect package generation module configured to generate a custom image effect package based on the custom effect control.

According to a third aspect, the present disclosure further provides an electronic device. The electronic device includes:
one or more processing apparatuses; and
a storage apparatus configured to store one or more programs, where
the one or more programs, when executed by the one or more processing apparatuses, cause
the one or more processing apparatuses to implement the image effect package generation method described above.

According to a fourth aspect, the present disclosure further provides a computer-readable medium having a computer program stored thereon, where the program, when executed by a processing apparatus, causes the image effect package generation method described above to be implemented.

### BRIEF DESCRIPTION OF DRAWINGS

FIG. 1 is a flowchart of an image effect package generation method according to an embodiment of the present disclosure;

FIG. 2 is a diagram of an example of creating an initial effect resource according to an embodiment of the present disclosure;

FIG. 3 is a diagram of an example of obtaining a custom effect resource according to an embodiment of the present disclosure;

FIG. 4 is a diagram of an example of creating a custom effect control according to an embodiment of the present disclosure;

FIG. 5 is a diagram of an example of generating a custom effect package according to an embodiment of the present disclosure;

FIG. 6 is a diagram of another example of generating a custom effect package according to an embodiment of the present disclosure;

FIG. 7 is a schematic diagram of a structure of an image effect package generation apparatus according to an embodiment of the present disclosure; and

FIG. 8 is a schematic diagram of a structure of an electronic device according to an embodiment of the present disclosure.

### DETAILED DESCRIPTION OF THE INVENTION

Embodiments of the present disclosure are described below with reference to the accompanying drawings. Although some embodiments of the present disclosure are shown in the accompanying drawings, the present disclosure may be implemented in various forms, and these embodiments are provided for understanding the present disclosure. The accompanying drawings and the embodiments of the present disclosure are for exemplary purposes only.

Various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

The concepts such as “first” and “second” mentioned in the present disclosure are only used to distinguish different apparatuses, modules, or units, and are not used to limit the sequence of functions performed by these apparatuses, modules, or units or interdependence.

The modifiers “one” and “a plurality of” mentioned in the present disclosure are illustrative and not restrictive, and those skilled in the art should understand that unless the context indicates otherwise, the modifiers should be understood as “one or more”.

The names of messages or information exchanged between a plurality of apparatuses in the implementations of the present disclosure are used for illustrative purposes only, and are not used to limit the scope of these messages or information.

A general effect panel in a node system may perform effect processing on one or more pictures.

The general effect panel is developed based on a mesh rendering system, in which a mesh rendering component is embedded. The component maintains an array of effect information (material) and an array of mesh information (mesh). A number of pieces of effect information is in a one-to-one correspondence with a number of pieces of mesh information. The use of information of each pair of material and mesh may implement effect rendering on a picture, thereby producing an effect picture. Such an output effect picture may be used as an input to the next effect processing, thereby implementing a combined effect. If an input to a material relies on an output from another material, the party being relied on in the array is required to precede the relying party, to ensure the relying party a correct order of execution and the relying party a correct output result.

A plurality of controls in the general effect panel are connected, which may allow convenient configuration of material and mesh while maintaining ordering relations to ensure proper execution of this control. The Effect Graph includes several core functional controls, namely, an effect control, an image input control (including a built-in image input control and a static image input control) and a scene output control, and other extended functional controls. A working principle of the Effect Graph is illustrated mainly from a work process of the core functional controls.

The core of the Effect Graph is the effect control. Each effect control may be configured with a pair of material and mesh for performing effect rendering on pictures. Each effect control has an output, which is an effect picture. Such an output of the effect control may be an output to the scene output control, or to a next effect control. Each effect control may accept a single or multiple inputs, which may be a built-in image, or an effect picture output by another effect control, or a static image. Such images may be set in the material held by the effect control for use during rendering. If an effect picture output by a current effect control is connected to the scene output control, it indicates that a rendering result of the current effect control may be observed in a scene.

FIG. 1 is a flowchart of an image effect package generation method according to an embodiment of the present disclosure. This embodiment is applicable to a case of generating a custom effect package. The method may be performed by an image effect package generation apparatus. The apparatus may be composed of hardware and/or software, and may generally be integrated in a device having an image effect package generation function. The device may be an electronic device such as a server, a mobile terminal, or a server cluster. As shown in FIG. 1, the method includes the following steps.

Step 110: Create an initial effect resource through a user-triggered creation operation.

The initial effect resource may be an invalid effect resource, that is, effect processing on a picture cannot be implemented based on such an initial effect resource. In this embodiment, an initial effect resource is selected randomly from a resource library in a resource panel, and added to the resource panel, so that creation of the initial effect resource is implemented.

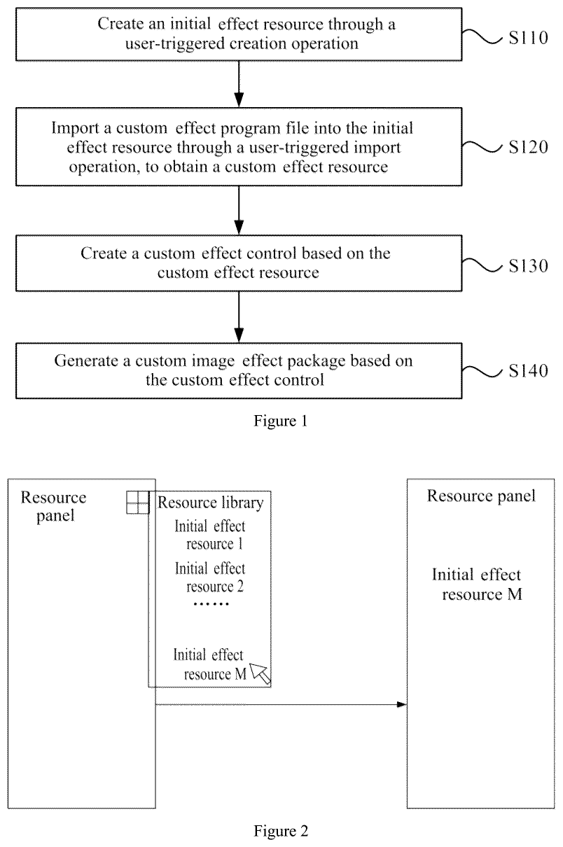

As an example, FIG. 2 is a diagram of an example of creating an initial effect resource according to an embodiment of the present disclosure. As shown in FIG. 2, a user clicks a “+” identifier in the resource panel to open the resource library, randomly selects an “initial effect resource M” from the resource library, and adds it to the resource panel, thereby creating the initial effect resource M.

Step 120: Import a custom effect program file into the initial effect resource through a user-triggered import operation, to obtain a custom effect resource.

The custom effect program file may be a file in any format supported by the node system, for example, a mshader file having an extension of “.mshader”. The custom feature program file contains configuration information, general parameter information, and shading information. The general (uniform) parameters may include a rendering order, an output length, width, and angle of a picture, etc. The shading information may be information of a color in which each pixel is shaded, and may include vertex shading information and fragment shading information.

In this embodiment, the custom effect program file may be imported into the initial effect resource by first importing the custom effect program file to the resource panel, and then setting the custom effect program file in a shader of the initial effect resource.

The process of importing a custom effect program file into the initial effect resource through a user-triggered import operation, to obtain a custom effect resource may include: obtaining the custom effect program file from a set storage path; importing the custom effect program file to a resource panel through the user-triggered import operation; and adding the custom effect program file, which is imported to the resource panel, to the initial effect resource, to obtain the custom effect resource.

In this embodiment, the custom effect program file is first obtained from the set storage path, then dragged into the resource panel in a drag-and-drop manner, and then selected from the “Shader” in the initial effect resource, so that the operations for adding the custom effect program file to the initial effect resource are implemented, and the custom effect resource is obtained.

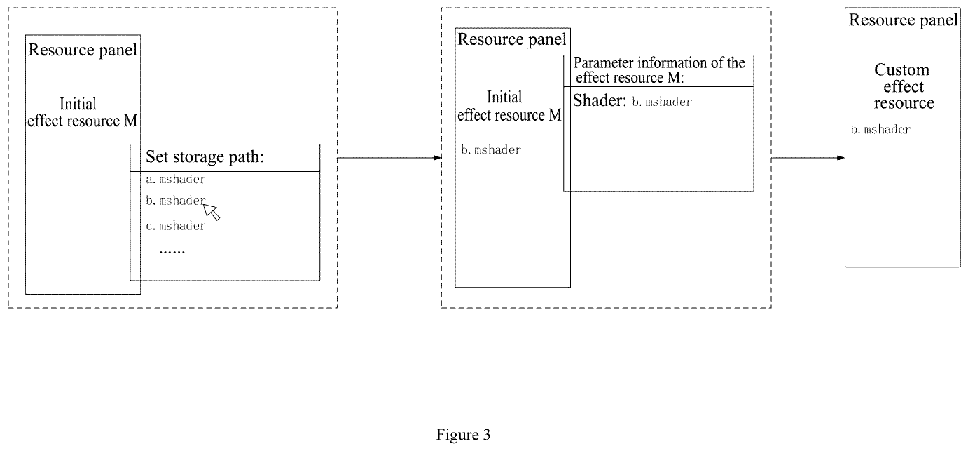

As an example, FIG. 3 is a diagram of an example of obtaining a custom effect resource according to an embodiment of the present disclosure. In view of the example described above, as shown in FIG. 3, custom effect program files are first found from a storage path, then a custom effect program file b is dragged and dropped in the resource panel, and then the custom effect program file b is selected from a “Shader” of the initial effect resource M, so that the custom effect resource is obtained.

In an embodiment, before the creating an initial effect resource through a user-triggered creation operation, the method further includes the following steps: editing the custom effect program file in a set editor through an edit operation of a user; and storing the custom effect program file into the set storage path.

The set storage path may be a folder pre-created by a user for storing the custom effect program file. The set editor may be a tool for editing program files in various formats. The user first creates an empty file in the mshader format in the set editor, writes the configuration information, the custom general parameter information, and the custom shading information in the empty .mshader file in a form of program code to obtain the custom effect program file, and finally stores the custom effect program file into the set storage path.

Step 130: Create a custom effect control based on the custom effect resource.

In this embodiment, an initial effect control is first created, and then the “material” of the initial effect control is selected as the custom effect resource to create the custom effect control.

The process of creating a custom effect control based on the custom effect resource may include: switching to a general effect panel through a user-triggered switch operation; creating an initial effect control in the general effect panel through a user-triggered creation operation; and setting the custom effect resource in the initial effect control to obtain the custom effect control.

In this embodiment, when an interface is switched to the general effect panel, the user clicks a “Create control” button to create the initial effect control, and the custom effect resource is selected from material options in an information box of the initial effect control to obtain the custom effect control.

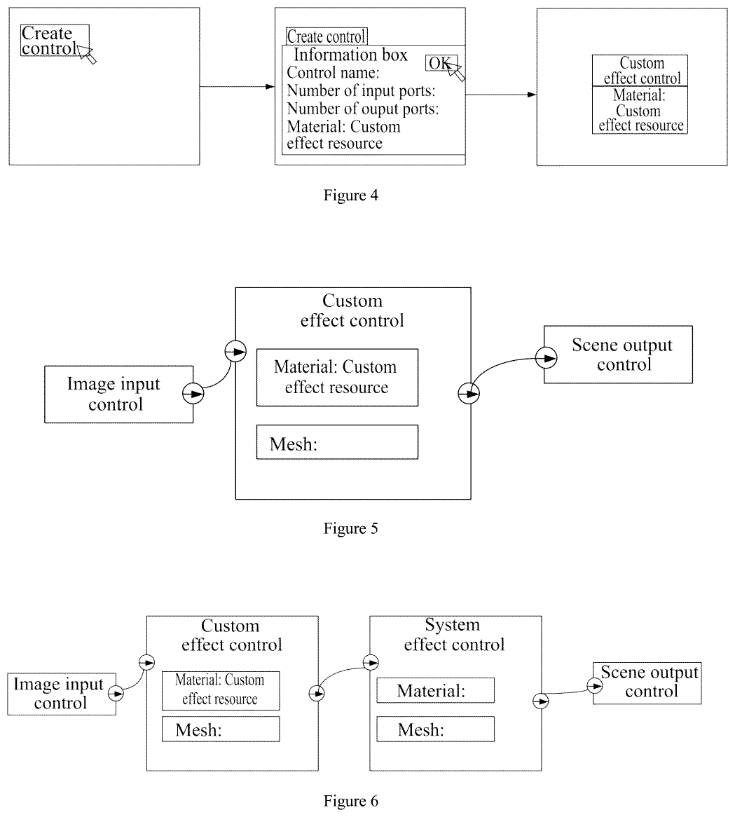

As an example, FIG. 4 is a diagram of an example of creating a custom effect control according to an embodiment of the present disclosure. As shown in FIG. 4, the user clicks the “Create control” button to enter the information box of the initial effect control, in which the user may enter a control name, selects the number of input ports and the number output ports for the effect control, selects the custom effect resource from the material options, and clicks an “OK” button to obtain the custom effect control.

Step 140: Generate a custom image effect package based on the custom effect control.

In this embodiment, generation of the image effect package needs an image input control, at least one effect control, and a scene output control.

The process of generating a custom image effect package based on the custom effect control may include: creating an image input control and a scene output control in the general effect panel through a user-triggered creation operation; connecting the image input control, the custom effect control, and the scene output control through a user-triggered connection operation according to a set rule; and generating the custom image effect package based on the connected image input control, custom effect control, and scene output control.

The set rule may include the following: the image input control is a start node; the effect control is an intermediate node; the scene output control is an end node; an input to the effect control is not null; and connections between effect controls do not form a closed loop. In this embodiment, the effect control includes one or more inputs and an output. The input of the effect control is connected to an output of the image input control or an output of another effect control. The output of the effect control is connected to an input of another effect control or an input of the scene output control.

The image input control is first connected to the custom effect control, and then to the scene output control as an end node in a required effect sequence. As an example, FIG. 5 is a diagram of an example of generating a custom effect package according to an embodiment of the present disclosure. As shown in FIG. 5, an output of the image input control is connected to an input of the custom effect control, and an output of the custom effect control is connected to an input of the scene output control. In this way, an input image is subjected to effect processing by the custom effect control, and is then input into the scene output control so that a final image with a custom effect added is displayed.

In this embodiment, the custom effect control may also be combined with other effect controls to obtain a custom combined effect package. The other effect controls may be system effect controls or other custom effect controls.

The custom image effect package may alternatively be generated based on the custom effect control by: creating at least one system effect control in the general effect panel through a user-triggered creation operation; connecting the image input control, the custom effect control, the at least one system effect control, and the scene output control through a user-triggered connection operation according to a set rule; and generating the custom image effect package based on the connected image input control, custom effect control, at least one system effect control, and scene output control.

The image input control is first connected to the custom effect control and the system effect control, and then to the scene output control as an end node in sequence in a required effect sequence. As an example, FIG. 6 is a diagram of another example of generating a custom effect package according to an embodiment of the present disclosure. As shown in FIG. 6, an output of the image input control is connected to an input of the custom effect control, an output of the custom effect control is connected to an input of the system effect control, and an output of the system effect control is connected to an input of the scene output control. In this way, an input image first passes through the custom effect control, which performs effect processing on the image and inputs the processed image into the system effect control; the system effect control then performs effect processing on the image; and finally, the image is input into the scene output control, so that a final image with a custom combined effect added is displayed.

In the technical solution of this embodiment, the initial effect resource is created through the user-triggered creation operation; the custom effect program file is imported into the initial effect resource through the user-triggered import operation, to obtain the custom effect resource; the custom effect control is created based on the custom effect resource; and the custom image effect package is generated based on the custom effect control. According to the image effect package generation method provided in this embodiment of the present disclosure, the custom effect program file is imported into the initial effect resource to obtain the custom effect resource, thereby generating the custom effect package based on the custom effect resource, which may implement generation of the custom effect package, and improve the diversity of image effect packages.

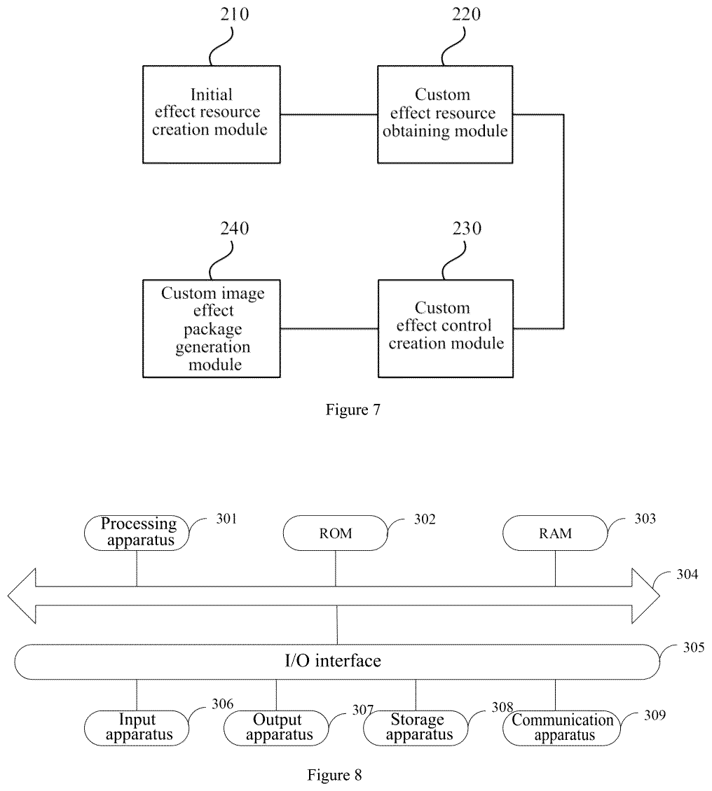

FIG. 7 is a schematic diagram of a structure of an image effect package generation apparatus according to an embodiment of the present disclosure. As shown in FIG. 7, the apparatus includes:

an initial effect resource creation module 210 configured to create an initial effect resource through a user-triggered creation operation; a custom effect resource obtaining module 220 configured to import a custom effect program file into the initial effect resource through a user-triggered import operation, to obtain a custom effect resource; a custom effect control creation module 230 configured to create a custom effect control based on the custom effect resource; and a custom image effect package generation module 240 configured to generate a custom image effect package based on the custom effect control.

In an embodiment, the custom effect resource obtaining module 220 is configured to: obtain the custom effect program file from a set storage path; import the custom effect program file to a resource panel through the user-triggered import operation; and add the custom effect program file, which is imported to the resource panel, to the initial effect resource, to obtain the custom effect resource.

In an embodiment, the apparatus further includes a custom effect program file editing module configured to:
edit the custom effect program file in a set editor through an edit operation of a user; and store the custom effect program file into the set storage path.

In an embodiment, the custom effect control creation module 230 is configured to: switch to a general effect panel through a user-triggered switch operation; create an initial effect control in the general effect panel through a user-triggered creation operation; and set the custom effect resource in the initial effect control to obtain the custom effect control.

In an embodiment, the custom image effect package generation module 240 is configured to:

create an image input control and a scene output control in the general effect panel through a user-triggered creation operation; connect the image input control, the custom effect control, and the scene output control through a user-triggered connection operation according to a set rule; and generate the custom image effect package based on the connected image input control, custom effect control, and scene output control.

In an embodiment, the custom image effect package generation module 240 is further configured to:

create at least one system effect control in the general effect panel through a user-triggered creation operation; connect the image input control, the custom effect control, the at least one system effect control, and the scene output control through a user-triggered connection operation according to a set rule; and generate the custom image effect package based on the connected image input control, custom effect control, at least one system effect control, and scene output control.

In an embodiment, the custom feature program file contains configuration information, general parameter information, and shading information.

The apparatus described above can perform the method provided in all the foregoing embodiments of the present disclosure, and has corresponding functional modules and effects for performing the method described above. For the technical details not described in detail in this embodiment, reference may be made to the method provided in all the above embodiments of the present disclosure.

Reference is made to FIG. 8 below, which is a schematic diagram of a structure of an electronic device 300 suitable for implementing the embodiments of the present disclosure. The electronic device 300 in this embodiment of the present disclosure may include, but is not limited to, mobile terminals such as a mobile phone, a notebook computer, a digital broadcast receiver, a personal digital assistant (PDA), a tablet computer (Portable Android Device, PAD), a portable multimedia player (PMP), and a vehicle-mounted terminal (such as a vehicle navigation terminal), and fixed terminals such as a digital television (TV) and a desktop computer, or various forms of servers such as a separate server or a server cluster. The electronic device 300 shown in FIG. 8 is merely an example, and shall not impose any limitation on the function and scope of use of the embodiments of the present disclosure.

As shown in FIG. 8, the electronic device 300 may include a processing apparatus (e.g., a central processing unit, a graphics processing unit, etc.) 301 that may perform a variety of appropriate actions and processing in accordance with a program stored in a read-only memory (ROM) 302 or a program loaded from a storage apparatus 308 into a random access memory (RAM) 303. The RAM 303 further stores various programs and data required for the operation of the electronic device 300. The processing apparatus 301, the ROM 302, and the RAM 303 are connected to each other through a bus 304. An input/output (I/O) interface 305 is also connected to the bus 304.

Generally, the following apparatuses may be connected to the I/O interface 305: an input apparatus 306 including, for example, a touch screen, a touchpad, a keyboard, a mouse, a camera, a microphone, an accelerometer, and a gyroscope; an output apparatus 307 including, for example, a liquid crystal display (LCD), a speaker, a vibrator, etc.; a storage apparatus 308 including, for example, a tape and a hard disk; and a communication apparatus 309. The communication apparatus 309 may allow the electronic device 300 to perform wireless or wired communication with other devices to exchange data. Although FIG. 8 shows the electronic device 300 having various apparatuses, it is not required to implement or have all of the shown apparatuses. It may be an alternative to implement or have more or fewer apparatuses.

According to an embodiment of the present disclosure, the process described above with reference to the flowcharts may be implemented as a computer software program. For example, this embodiment of the present disclosure includes a computer program product, which includes a computer program carried on a computer-readable medium, where the computer program includes program code for performing the image effect package generation method. In such an embodiment, the computer program may be downloaded from a network through the communication apparatus 309 and installed, installed from the storage apparatus 308, or installed from the ROM 302. When the computer program is executed by the processing apparatus 301, the above-mentioned functions defined in the method of the embodiment of the present disclosure are performed.

The above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. Examples of the computer-readable storage medium may include, but are not limited to: an electrical connection having one or more wires, a portable computer magnetic disk, a hard disk, a RAM, a ROM, an erasable programmable read-only memory (EPROM) or a flash memory, an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server can communicate using any currently known or future-developed network protocol such as a HyperText Transfer Protocol (HTTP), and may be connected to digital data communication (for example, communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: create an initial effect resource through a user-triggered creation operation; import a custom effect program file into the initial effect resource through a user-triggered import operation, to obtain a custom effect resource; create a custom effect control based on the custom effect resource; and generate a custom image effect package based on the custom effect control.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including LAN or WAN, or may be connected to an external computer (for example, connected over the Internet using an Internet service provider).

The flowcharts and block diagrams in the accompanying drawings illustrate the possibly implemented architecture, functions, and operations of the system, method, and computer program product according to multiple embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself under a circumstance.

The functions described herein above may be performed at least partially by one or more hardware logic components. For example, without limitation, exemplary types of hardware logic components that may be used include: a field programmable gate array (FPGA), an application-specific integrated circuit (ASIC), application-specific standard parts (ASSP), a system-on-chip (SOC) system, a complex programming logic device (CPLD), and the like.

In the context of the present disclosure, a machine-readable medium may be a tangible medium that may contain or store a program used by or in combination with an instruction execution system, apparatus, or device. A machine-readable medium may be a machine-readable signal medium or a machine-readable storage medium. A machine-readable medium may include, but is not limited to, electronic, magnetic, optical, electromagnetic, infrared, or semiconductor systems, apparatus, or devices, or any suitable combination thereof. Examples of the machine-readable storage medium may include an electrical connection based on one or more wires, a portable computer disk, a hard disk, a RAM, a ROM, an EPROM or a flash memory, an optical fiber, a CD-ROM, an optical storage device, a magnetic storage device, or any suitable combination thereof.

According to one or more of the embodiments of the present disclosure, the embodiment of the present disclosure discloses an image effect package generation method. The method includes:
creating an initial effect resource through a user-triggered creation operation;
importing a custom effect program file into the initial effect resource through a user-triggered import operation, to obtain a custom effect resource;
creating a custom effect control based on the custom effect resource; and
generating a custom image effect package based on the custom effect control.

According to one or more embodiments of the embodiments of the present disclosure, the importing a custom effect program file into the initial effect resource through a user-triggered import operation, to obtain a custom effect resource includes:
obtaining the custom effect program file from a set storage path;
importing the custom effect program file to a resource panel through the user-triggered import operation; and
adding the custom effect program file, which is imported to the resource panel, to the initial effect resource, to obtain the custom effect resource.

According to one or more embodiments of the embodiments of the present disclosure, before the creating an initial effect resource through a user-triggered creation operation, the method further includes:
editing the custom effect program file in a set editor through an edit operation of a user; and
storing the custom effect program file into the set storage path.

According to one or more embodiments of the embodiments of the present disclosure, the creating a custom effect control based on the custom effect resource includes:
switching to a general effect panel through a user-triggered switch operation;
creating an initial effect control in the general effect panel through a user-triggered creation operation; and
setting the custom effect resource in the initial effect control to obtain the custom effect control.

According to one or more embodiments of the embodiments of the present disclosure, the generating a custom image effect package based on the custom effect control includes: creating an image input control and a scene output control in the general effect panel through a user-triggered creation operation;
connecting the image input control, the custom effect control, and the scene output control through a user-triggered connection operation according to a set rule; and
generating the custom image effect package based on the connected image input control, custom effect control, and scene output control.

According to one or more embodiments of the embodiments of the present disclosure, the generating a custom image effect package based on the custom effect control further includes:
creating at least one system effect control in the general effect panel through a user-triggered creation operation;
connecting the image input control, the custom effect control, the at least one system effect control, and the scene output control through a user-triggered connection operation according to a set rule; and
generating the custom image effect package based on the connected image input control, custom effect control, at least one system effect control, and scene output control.

According to one or more embodiments of the embodiments of the present disclosure, the custom feature program file contains configuration information, general parameter information, and shading information.

1. An image effect package generation method, comprising:
creating an initial effect resource through a user-triggered creation operation;
importing a custom effect program file into the initial effect resource through a user-triggered import operation, to obtain a custom effect resource;
creating a custom effect control based on the custom effect resource; and
generating a custom image effect package based on the custom effect control.

2. The method according to claim 1, wherein the importing a custom effect program file into the initial effect resource through a user-triggered import operation, to obtain a custom effect resource comprises:
obtaining the custom effect program file from a set storage path;
importing the custom effect program file to a resource panel through the user-triggered import operation; and
adding the custom effect program file, which is imported to the resource panel, to the initial effect resource, to obtain the custom effect resource.

3. The method according to claim 2, before the creating an initial effect resource through a user-triggered creation operation, further comprising:
editing the custom effect program file in a set editor through an edit operation of a user; and
storing the custom effect program file into the set storage path.

4. The method according to claim 1, wherein the creating a custom effect control based on the custom effect resource comprises:
switching to a general effect panel through a user-triggered switch operation;
creating an initial effect control in the general effect panel through a user-triggered creation operation; and
setting the custom effect resource in the initial effect control to obtain the custom effect control.

5. The method according to claim 4, wherein the generating a custom image effect package based on the custom effect control comprises:
creating an image input control and a scene output control in the general effect panel through a user-triggered creation operation;
connecting the image input control, the custom effect control, and the scene output control through a user-triggered connection operation according to a set rule; and
generating the custom image effect package based on the connected image input control, custom effect control, and scene output control.

6. The method according to claim 5, wherein the generating a custom image effect package based on the custom effect control further comprises:
creating at least one system effect control in the general effect panel through a user-triggered creation operation;
connecting the image input control, the custom effect control, the at least one system effect control, and the scene output control through a user-triggered connection operation according to a set rule; and
generating the custom image effect package based on the connected image input control, custom effect control, at least one system effect control, and scene output control.

7. The method according to claim 1, wherein the custom effect program file contains configuration information, general parameter information, and shading information.

8. (canceled)

9. An electronic device, comprising:
at least one processing apparatus; and
a storage apparatus configured to store at least one program, wherein
the at least one program, when executed by the at least one processing apparatus, causes the at least one processing apparatus to:
create an initial effect resource through a user-triggered creation operation;
import a custom effect program file into the initial effect resource through a user-triggered import operation, to obtain a custom effect resource;
create a custom effect control based on the custom effect resource; and
generate a custom image effect package based on the custom effect control.

10. A non-transitory computer-readable medium having a computer program stored thereon, wherein the program, when executed by a processing apparatus, causes the processing apparatus to:
create an initial effect resource through a user-triggered creation operation;
import a custom effect program file into the initial effect resource through a user-triggered import operation, to obtain a custom effect resource;
create a custom effect control based on the custom effect resource; and
generate a custom image effect package based on the custom effect control.

11. The device according to claim 9, wherein the at least one program causes the at least one processing apparatus to import a custom effect program file into the initial effect resource through a user-triggered import operation, to obtain a custom effect resource by causing the at least one process apparatus to:
obtain the custom effect program file from a set storage path;
import the custom effect program file to a resource panel through the user-triggered import operation; and
add the custom effect program file, which is imported to the resource panel, to the initial effect resource, to obtain the custom effect resource.

12. The device according to claim 11, before causing the at least one processing apparatus to create an initial effect resource through a user-triggered creation operation, the at least one program causes the at least one processing apparatus to:
edit the custom effect program file in a set editor through an edit operation of a user; and
store the custom effect program file into the set storage path.

13. The device according to claim 9, wherein the at least one program causes the at least one processing apparatus to create a custom effect control based on the custom effect resource by causing the at least one process apparatus to:
switch to a general effect panel through a user-triggered switch operation;
create an initial effect control in the general effect panel through a user-triggered creation operation; and
set the custom effect resource in the initial effect control to obtain the custom effect control.

14. The device according to claim 13, wherein the at least one program causes the at least one processing apparatus to generate a custom image effect package based on the custom effect control by causing the at least one process apparatus to:
create an image input control and a scene output control in the general effect panel through a user-triggered creation operation;
connect the image input control, the custom effect control, and the scene output control through a user-triggered connection operation according to a set rule; and
generate the custom image effect package based on the connected image input control, custom effect control, and scene output control.

15. The device according to claim 14, wherein the at least one program causes the at least one processing apparatus to generate a custom image effect package based on the custom effect control further by causing the at least one process apparatus to:
create at least one system effect control in the general effect panel through a user-triggered creation operation;
connect the image input control, the custom effect control, the at least one system effect control, and the scene output control through a user-triggered connection operation according to a set rule; and
generate the custom image effect package based on the connected image input control, custom effect control, at least one system effect control, and scene output control.

16. The device according to claim 9, wherein the custom effect program file contains configuration information, general parameter information, and shading information.

17. The medium according to claim 10, wherein the program causes the processing apparatus to import a custom effect program file into the initial effect resource through a user-triggered import operation, to obtain a custom effect resource by causing the process apparatus to:
obtain the custom effect program file from a set storage path;
import the custom effect program file to a resource panel through the user-triggered import operation; and
add the custom effect program file, which is imported to the resource panel, to the initial effect resource, to obtain the custom effect resource.

18. The medium according to claim 17, before causing the processing apparatus to create an initial effect resource through a user-triggered creation operation, the program causes the processing apparatus to:
edit the custom effect program file in a set editor through an edit operation of a user; and
store the custom effect program file into the set storage path.

19. The medium according to claim 10, wherein the program causes the processing apparatus to create a custom effect control based on the custom effect resource by causing the process apparatus to:
switch to a general effect panel through a user-triggered switch operation;
create an initial effect control in the general effect panel through a user-triggered creation operation; and
set the custom effect resource in the initial effect control to obtain the custom effect control.

20. The medium according to claim 19, wherein the program causes the processing apparatus to generate a custom image effect package based on the custom effect control by causing the process apparatus to:
create an image input control and a scene output control in the general effect panel through a user-triggered creation operation;
connect the image input control, the custom effect control, and the scene output control through a user-triggered connection operation according to a set rule; and
generate the custom image effect package based on the connected image input control, custom effect control, and scene output control.

21. The medium according to claim 20, wherein the program causes the processing apparatus to generate a custom image effect package based on the custom effect control further by causing the process apparatus to:
create at least one system effect control in the general effect panel through a user-triggered creation operation;
connect the image input control, the custom effect control, the at least one system effect control, and the scene output control through a user-triggered connection operation according to a set rule; and
generate the custom image effect package based on the connected image input control, custom effect control, at least one system effect control, and scene output control.
